(19) United States
(12) Patent Application Publication
(10) Pub. No.: US 2016/0064004 A1
(43) Pub. Date: Mar. 3, 2016

(54) MULTIPLE CHANNEL AUDIO SIGNAL ENCODER MODE DETERMINER

(71) Applicant: NOKIA TECHNOLOGIES OY, Espoo (FI)

(72) Inventors: Lasse Juhani LAAKSONEN, Tampere (FI); Adriana VASILACHE, Tampere (FI); Anssi Sakari RÄMÖ, Tampere (FI); Mikko Tapio TAMMI, Tampere (FI)

(21) Appl. No.: 14/783,487

(22) PCT Filed: Apr. 15, 2013
(86) PCT No.: PCT/FI2013/050413

§ 371 Date: Oct. 9, 2015

(51) Int. Cl. G10L 19/008

(52) U.S. Cl. CPC G10L 19/008

(57) ABSTRACT

It is inter alia disclosed a method comprising: determining an indication of similarity between a first audio frame of a multiple channel input audio signal and a second audio frame of the multiple channel input audio signal; and determining a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.

### FIELD

The present application relates to a multiple channel audio signal encoder, and in particular, but not exclusively to a stereo audio signal encoder for use in portable apparatus.

### BACKGROUND

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise). These types of coders typically do not utilise a speech model for the coding process, rather they use processes for representing all types of audio signals, including speech. Speech encoders and decoders (codecs) can be considered to be audio codecs which are optimised for speech signals, and can operate at either a fixed or variable bit rate.

An audio codec can also be configured to operate with varying bit rates. At lower bit rates, such an audio codec may be optimized to work with speech signals at a coding rate equivalent to a pure speech codec. At higher bit rates, the audio codec may code any signal including music, background noise and speech, with higher quality and performance. A variable-rate audio codec can also implement an embedded scalable coding structure and bitstream, where additional bits (a specific amount of bits is often referred to as a layer) improve the coding upon lower rates, and where the bitstream of a higher rate may be truncated to obtain the bitstream of a lower rate coding. Such an audio codec may utilize a codec designed purely for speech signals as the core layer or lowest bit rate coding.

A particular coding rate or coding layer can be considered as a mode of operation of the speech or audio codec. An embedded scalable coding structure can operate in any one of a number of different coding modes, where a particular coding mode may correspond to a particular layer of coding and/or a particular rate of coding.

Speech or audio codecs can perform signal analysis on the input audio signal prior to coding in order to determine a particular coding mode. However, this can be a complex task burdening the processor with a significant computational overhead.

Multiple channel audio codecs can perform a multiple channel to single channel down mixing process in order to form a main channel which can then be subsequently encoded with any suitable audio codec, such as a multi-rate mono audio codec. Additionally, multiple channel audio codecs may encode spatial audio parameters to represent the multiple audio channels in relation to the down mixed main channel.

Encoding of spatial audio parameters can also operate in any of a number of different coding modes, whereby the coding mode may also be determined by analysing the input audio signal.

However, multiple channel audio codecs of the form described above can incur a significant overall computational burden when determination of the coding mode of the multiple channel section of the codec is followed by the determination of the coding mode of the subsequent mono coding section of the codec.

Furthermore, it may not be possible to combine the signal analysis required for coding mode determination in the multiple channel section of the codec with the signal analysis required for coding mode selection in the mono coding section of the codec. This is due to coding mode selection for the multiple channel section of the codec having an influence on the selection for the coding mode of the following mono coding section of the codec.

### SUMMARY

There is provided according to a first aspect a method comprising: determining an indication of similarity between a first audio frame of a multiple channel input audio signal and a second audio frame of the multiple channel input audio signal; and determining a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.

The multiple channel audio spatial encoder may be arranged to operate in one of a plurality of coding modes, and the mono audio encoder may be arranged to operate in one of a further plurality of further coding modes.

The indication of similarity may be a measure of the evolution of a spectral shape between the first audio frame of the multiple channel input audio signal and the second audio frame of the multiple channel input audio signal for each channel of the multiple channel input audio signal.

The measure of the evolution of the spectral shape may signify a change in the relative dominance of the audio signal level from one channel to another channel of the multichannel audio signal over the duration from the first audio frame to the second audio frame.

The indication of similarity may be dependent on the evolution of spatial audio cues between the first audio frame of the multiple channel input audio signal and the second audio frame of the multiple channel input audio signal for each channel of the multiple channel input audio signal.

The measure of the evolution of the spatial audio cues can signify a transition of the spatial audio cues within the audio space over the duration from the first audio frame to the second audio frame.

The data indicating the coding mode of the mono audio encoder for the first audio frame of the multiple channel input audio signal may comprise metric data used to derive the coding mode of the mono audio encoder.

The metric data may comprise at least one of: voice activity detector data; and a pitch evolution vector.

The data indicating the coding mode of the mono audio encoder for the first audio frame may indicate whether the mono audio encoder operated in either a speech signal mode of encoding or an audio signal mode of encoding.

The mono audio encoder may be a variable bit rate mono audio encoder, wherein each coding mode of the variable bit rate mono audio encoder may correspond to an operating bit rate of the mono audio encoder, and wherein the data indicating the coding mode of the mono audio encoder for the first audio frame may indicate the operating bit rate of the mono encoder.

The first audio frame of the multiple channel input audio signal may be a previous audio frame of the multiple channel input audio signal, and the second audio frame of the multiple channel input audio signal may be a current audio frame of the multiple channel input audio signal.

The method may further comprise: converting the second audio frame of the multiple channel input audio signal to a mono audio signal; and encoding the mono audio signal with the mono audio encoder.

According to a second aspect there is provided an apparatus configured to: determine an indication of similarity between a first audio frame of a multiple channel input audio signal and a second audio frame of the multiple channel input audio signal; and determine a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.

The multiple channel audio spatial encoder may be arranged to operate in one of a plurality of coding modes, and the mono audio encoder may be arranged to operate in one of a further plurality of further coding modes.

The indication of similarity may be a measure of the evolution of a spectral shape between the first audio frame of the multiple channel input audio signal and the second audio frame of the multiple channel input audio signal for each channel of the multiple channel input audio signal.

The measure of the evolution of the spectral shape may signify a change in the relative dominance of the audio signal level from one channel to another channel of the multichannel audio signal over the duration from the first audio frame to the second audio frame.

The indication of similarity may be dependent on the evolution of spatial audio cues between the first audio frame of the multiple channel input audio signal and the second audio frame of the multiple channel input audio signal for each channel of the multiple channel input audio signal.

The measure of the evolution of the spatial audio cues may signify a transition of the spatial audio cues within the audio space over the duration from the first audio frame to the second audio frame.

The data indicating the coding mode of the mono audio encoder for the first audio frame of the multiple channel input audio signal may comprise metric data used to derive the coding mode of the mono audio encoder.

The metric data may comprise at least one of: voice activity detector data; and a pitch evolution vector.

The data indicating the coding mode of the mono audio encoder for the first audio frame may indicate whether the mono audio encoder operated in either a speech signal mode of encoding or an audio signal mode of encoding.

The mono audio encoder may be a variable bit rate mono audio encoder, wherein each coding mode of the variable bit rate mono audio encoder corresponds to an operating bit rate of the mono audio encoder, and the data indicating the coding mode of the mono audio encoder for the first audio frame may indicate the operating bit rate of the mono encoder.

The first audio frame of the multiple channel input audio signal may be a previous audio frame of the multiple channel input audio signal, and the second audio frame of the multiple channel input audio signal may be a current audio frame of the multiple channel input audio signal.

The apparatus may be further configured to: convert the second audio frame of the multiple channel input audio signal to a mono audio signal; and encode the mono audio signal with the mono audio encoder.

According to a third aspect there is provide an apparatus comprising at least one processor and at least one memory including computer program code for one or more programs, the at least one memory and the computer program code configured to, with the at least one processor, cause the apparatus at least to:

determine an indication of similarity between a first audio frame of a multiple channel input audio signal and a second audio frame of the multiple channel input audio signal; and determine a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.

The multiple channel audio spatial encoder may be arranged to operate in one of a plurality of coding modes, and wherein the mono audio encoder maybe arranged to operate in one of a further plurality of further coding modes.

The indication of similarity may be a measure of the evolution of a spectral shape between the first audio frame of the multiple channel input audio signal and the second audio frame of the multiple channel input audio signal for each channel of the multiple channel input audio signal.

The measure of the evolution of the spectral shape may signify a change in the relative dominance of the audio signal level from one channel to another channel of the multichannel audio signal over the duration from the first audio frame to the second audio frame.

The indication of similarity may be dependent on the evolution of spatial audio cues between the first audio frame of the multiple channel input audio signal and the second audio frame of the multiple channel input audio signal for each channel of the multiple channel input audio signal.

The measure of the evolution of the spatial audio cues may signify a transition of the spatial audio cues within the audio space over the duration from the first audio frame to the second audio frame.

The data indicating the coding mode of the mono audio encoder for the first audio frame of the multiple channel input audio signal may comprise metric data used to derive the coding mode of the mono audio encoder.

The metric data may comprise at least one of: voice activity detector data; and a pitch evolution vector.

The data indicating the coding mode of the mono audio encoder for the first audio frame may indicate whether the mono audio encoder operated in either a speech signal mode of encoding or an audio signal mode of encoding.

The mono audio encoder may be a variable bit rate mono audio encoder, wherein each coding mode of the variable bit rate mono audio encoder may correspond to an operating bit rate of the mono audio encoder, and wherein data indicating the coding mode of the mono audio encoder for the first audio frame may indicate the operating bit rate of the mono encoder.

The first audio frame of the multiple channel input audio signal may be a previous audio frame of the multiple channel input audio signal, and wherein the second audio frame of the multiple channel input audio signal may be a current audio frame of the multiple channel input audio signal.

The at least one memory and the computer program code may be further configured to, with the at least one processor, cause the apparatus at least to: convert the second audio frame of the multiple channel input audio signal to a mono audio signal; and encode the mono audio signal with the mono audio encoder.

A computer program code may be configured to realize the actions of the method herein when executed by a processor.

An electronic device may comprise apparatus as described herein.

A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing some embodiments;

FIG. 2 shows schematically an audio coding system according to some embodiments;

FIG. 3 shows schematically an encoder as shown in FIG. 2 according to some embodiments;

FIG. 4 shows schematically the operation of the multichannel audio coding mode determiner within the encoder of FIG. 3; and

FIG. 5 shows schematically the decoder as shown in FIG. 2 according to some embodiments.

### DESCRIPTION OF SOME EMBODIMENTS

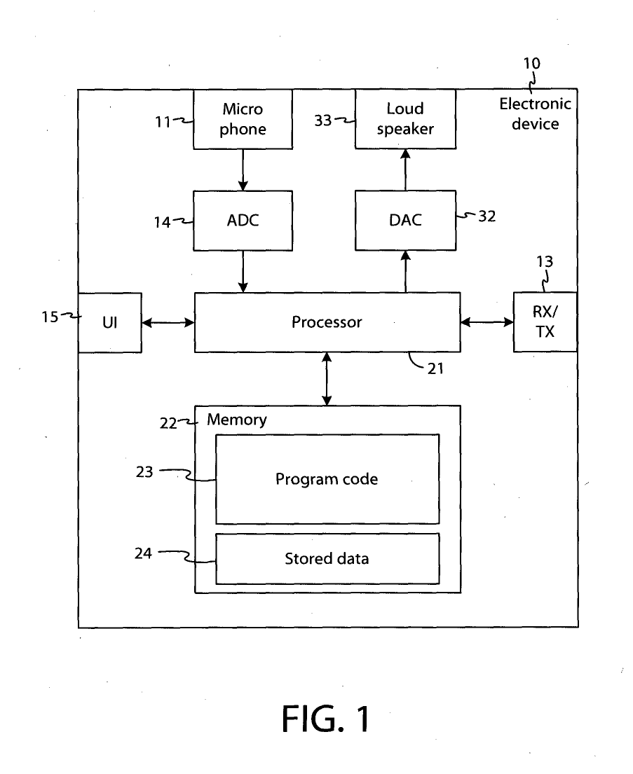

The following describes in more detail possible multichannel speech and audio codecs, including layered or scalable speech and audio codecs which can operate either at a constant bit rate or a variable bit rate In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The implemented program codes in some embodiments comprise a multichannel or stereo encoding or decoding code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

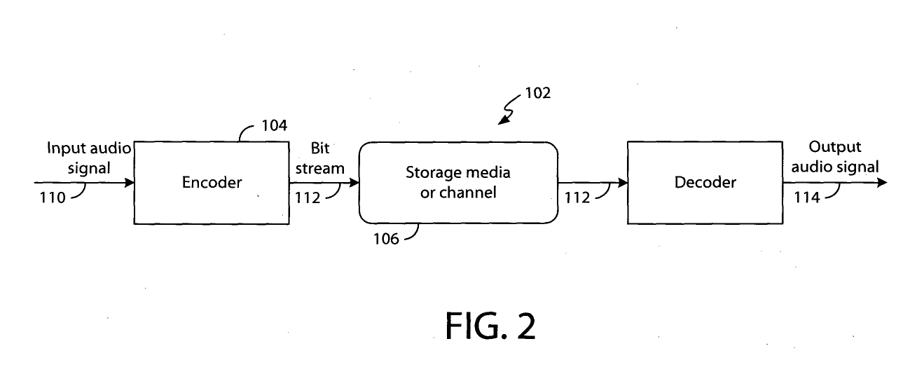

The processor 21 in such embodiments then processes the digital audio signal in the same way as described with reference to FIGS. 2 to 5.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

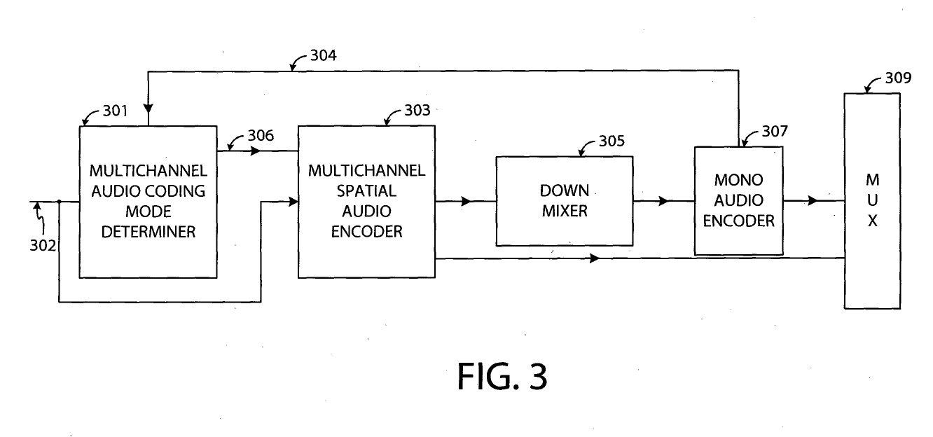

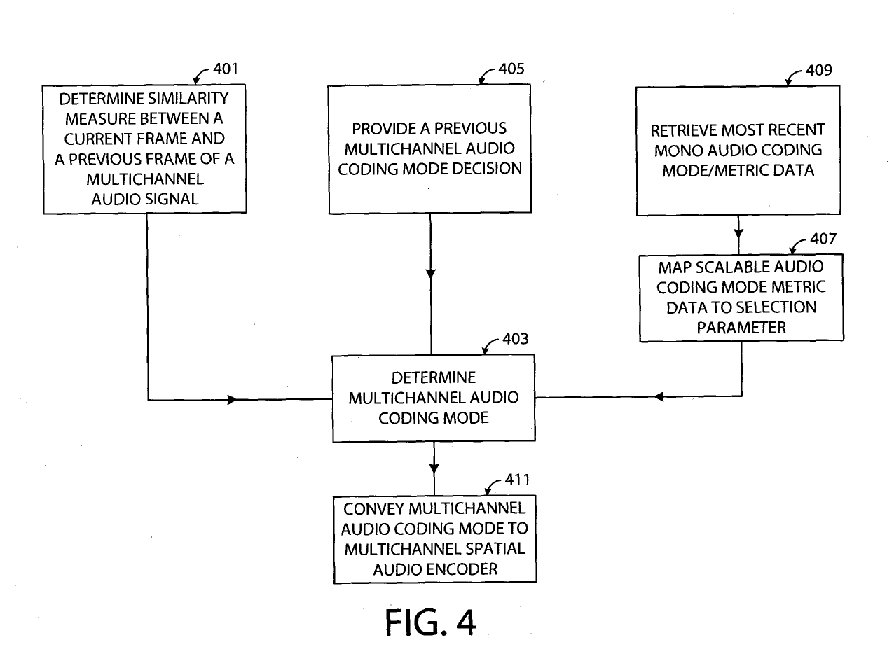

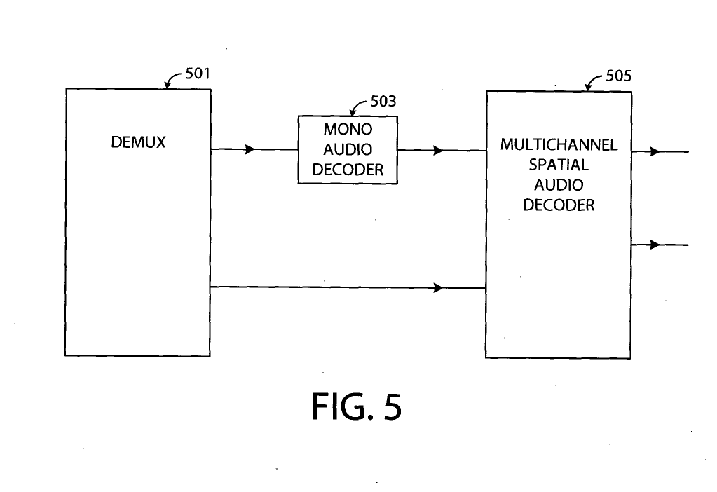

It would be appreciated that the schematic structures described in FIGS. 3 and 5, and the method steps shown in FIG. 4 represent only a part of the operation of an audio codec and specifically part of a multichannel encoder/decoder apparatus or method as exemplarily shown implemented in the apparatus shown in FIG. 1.

The general operation of audio codecs as employed by embodiments is shown in FIG. 2. General audio coding/decoding systems (codecs) comprise both an encoder and a decoder, as illustrated schematically in FIG. 2. However, it would be understood that some embodiments can implement one of either the encoder or decoder, or both the encoder and decoder. Illustrated by FIG. 2 is a system 102 with an encoder 104 a storage or media channel 106 and a decoder 108. It would be understood that as described above some embodiments can comprise or implement one of the encoder 104 or decoder 108 or both the encoder 104 and decoder 108.

The encoder 104 compresses an input audio signal 110 producing a bit stream 112, which in some embodiments can be stored or transmitted through a media channel 106. The encoder 104 furthermore can comprise a multichannel audio encoder 151 as part of the overall encoding operation. It is to be understood that the multichannel audio encoder may be part of the overall encoder 104 or a separate encoding module. The encoder 104 can also comprise a multi-channel encoder that encodes more than two audio signals.

The bit stream 112 can be received within the decoder 108. The decoder 108 decompresses the bit stream 112 and produces an output audio signal 114. The decoder 108 can comprise a multichannel audio decoder as part of the overall decoding operation. It is to be understood that the multichannel audio decoder may be part of the overall decoder 108 or a separate decoding module. The decoder 108 can also comprise a multi-channel decoder that decodes more than two audio signals.

The bit rate of the bit stream 112 and the quality of the output audio signal 114 in relation to the input signal 110 are the main features which define the performance of the coding system 102.

FIG. 3 shows schematically the encoder 104 according to some embodiments.

The concept for the embodiments as described herein is to determine and apply multichannel audio coding mode determination for the subsequent coding of a multiple channel audio signal by a multichannel spatial audio codec. The multichannel spatial audio codec being configured to encode spatial audio parameters associated with the multichannel audio signal prior to the multiple channel audio signal being converted to a mono signal and being subsequently encoded by a mono audio encoder. To that respect FIG. 3 depicts an example encoder 104 according to some embodiments.

The multiple channel audio spatial encoder may be arranged to operate in one of a plurality of coding modes, and the mono audio encoder may be arranged to operate in one of a further plurality of further coding modes.

The encoder 104 in some embodiments can comprise a multichannel audio coding mode determiner 301 which can be configured to receive the multiple channel input audio signal along the input 302. Additionally, the multichannel audio coding mode determiner 301 may also be arranged to receive a further input from a mono audio encoder 307. This further input to the multichannel audio coding mode determiner 301 is depicted as the connection 304 in FIG. 3.

FIG. 4 shows schematically in a flow diagram the operation of the multichannel audio coding mode determiner 301. The operation of the multichannel audio coding mode determiner 301 will be described from herein in conjunction with FIG. 4.

In embodiments the multichannel audio coding mode determiner 301 can provide a multichannel audio coding mode decision for the subsequent multichannel spatial audio encoder 303.

It is to be appreciated in embodiments that the multichannel spatial audio encoder 303 may extract and encode binaural spatial audio parameters derived from the input multiple channel audio signal 302. Subsequent stages of the encoder 104 may then downmix the multichannel input audio signal to a mono (or main) channel audio signal which may then be encoded by a suitable audio encoder.

In a first group of embodiments the mono channel audio signal may be encoded by a multi-rate speech and audio encoder. The mono audio encoder 307 may operate at a constant or variable bit rate.

It is to be further appreciated that a first group of embodiments may be configured to encode an input stereophonic audio signal 302, comprising a left and right channel.

In some embodiments the multichannel audio coding mode decision may be based on the combination of a number of different criteria.

In a first group of embodiments the multichannel audio coding mode decision may be based on the combination of three separate criteria.

In embodiments the first criteria upon which the multichannel audio coding mode decision may be based upon is the similarity between a current frame of the input multiple channel audio signal 302 and at least one previous frame of the input multichannel audio signal 302.

In a first group of embodiments the multichannel audio coding mode determiner 301 may use a measure of similarity between a current frame of the input multiple channel audio signal and the immediately previous frame of the input multiple channel audio signal.

In other words embodiments may have the means for determining an indication of similarity between a first audio frame of a multiple channel input audio signal and a second audio frame of the multiple channel input audio signal. In some embodiments the first audio frame is a previous audio frame of the multiple channel input audio signal, and the second audio frame is a current audio frame of the multiple channel input audio signal.

In embodiments the similarity measure may be based on the evolution of the spectral shape between the current frame of the input multiple channel audio signal and previous frame of the input multiple channel audio signal. The evolution of the spectral shape may be monitored on a per channel basis. In other words the evolution of the spectral shape may be monitored on a per frame basis for each separate channel of the input multiple channel audio signal.

In other words in embodiments the indication of similarity may be a measure of the evolution of a spectral shape between the first audio frame of the multiple channel input audio signal and the second audio frame of the multiple channel input audio signal for each channel of the multiple channel input audio signal. In some embodiments the first audio frame is a previous audio frame of the multiple channel input audio signal, and the second audio frame is a current audio frame of the multiple channel input audio signal.

In embodiments, the similarity measure based on the evolution of the spectral shape may be derived from metrics describing the tonality or total energy of the audio signal for each channel of the input multiple channel audio signal.

In other embodiments the similarity measure based on the evolution of the spectral shape may be determined on a per frequency band basis. These frequency bands can be linearly spaced, or be perceptual or psychoacoustically allocated according to the critical bands of the human hearing system.

In other embodiments the similarity measure may be based on the evolution of audio spatial cues between the current frame of the input multichannel audio signal and a previous frame of the input multichannel audio signal. As above, the evolution of the audio spatial cues may also be monitored on a per channel basis. In other words the evolution of the audio spatial cues may be monitored on a per frame basis for each separate channel of the input multichannel audio signal.

As above in other embodiments the similarity measure based on the evolution of audio spatial cues may also be determined on a per frequency band basis. These frequency bands can be linearly spaced, or be perceptual or psychoacoustically allocated according to the critical bands of the human hearing system.

Some embodiments may monitor the multiple channels across current and previous frames of the input multichannel audio signal 302 for transitory behaviour. This may take the form of a monitoring the input audio signal waveform across a previous audio frame to a current audio frame for a change in dominance of the audio signal from one channel to the other.

In other words the measure of the evolution of the spectral shape may signify a change in the relative dominance of the audio signal level from one channel to another channel of the multichannel audio signal over the duration from the first audio frame to the second audio frame. In some embodiments the first audio frame is a previous audio frame of the multiple channel input audio signal, and the second audio frame is a current audio frame of the multiple channel input audio signal.

In other embodiments other forms of transitory behaviour in the input multiple channel audio signal may include a transition of the spatial audio cues from a previous frame to the current frame of the input multiple channel audio signal 302.

In other words the measure of the evolution of the spatial audio cues may signify a transition of the spatial audio cues within the audio space over the duration from the first audio frame to the second audio frame. In some embodiments the first audio frame is a previous audio frame of the multiple channel input audio signal, and the second audio frame is a current audio frame of the multiple channel input audio signal.

The processing step of determining the similarity measure between a previous frame and a current frame of the input multiple channel audio signal 302 is shown as processing step 401 in FIG. 4.

In some embodiments the output from processing step 401 may be a binary indicator indicating whether the current frame of the input multichannel audio signal is determined to be similar to a previous frame of the input multichannel audio frame.

In other embodiments the output from processing step 401 may be set of metrics describing the similarity measures. For example, in embodiments which monitor the transitory behaviour of the audio signal across the current and previous audio frames the output from the processing step 401 may take the form of a set of indicators indicating whether there has been a transition in the dominance from one channel to another of the audio signal waveform, or whether there has been a transition in the audio spatial cues from a previous to a current audio waveform.

The output of the processing step 401, in other words indicator used to indicate whether the current input frame of the multichannel audio signal is similar to a previous input frame of the multichannel audio signal may be an input to the multichannel audio encoder mode decision processing step 403.

In embodiments the multichannel audio encoder mode decision processing step 403 can also comprise further inputs upon which to derive the multichannel coding mode decision.

In some embodiments the multichannel audio coding mode decision processing step 403 may receive a further input comprising a multichannel audio coding mode decision for a previous frame of the input multichannel audio signal. This functionality may be realized in the multichannel audio coding mode determiner 301 by storing in memory the multichannel audio coding mode decision for a current frame and applying the decision to a subsequent frame of the input multichannel audio signal.

In the first group of embodiments the multichannel audio coding mode decision for a previous frame of the input multichannel audio signal may form the second of the three criteria upon which the decision for the multichannel audio coding mode for the current frame is made.

The processing step of providing a previous multichannel audio coding mode decision is shown as processing step 405 in FIG. 4.

In embodiments the multichannel audio encoder mode decision processing step 403 may also receive a further input based at least in part on a coding mode of the mono audio encoder 307 for a previous audio frame.

The previous mono audio encoder coding mode may be provided by the mono audio encoder 307 to the multichannel audio coding mode determiner 301 via the connection 304.

In some embodiments, in which the mono audio encoder 307 is a variable rate mono audio encoder capable of operating at any one of a number of coding rates, the previous mono audio coding mode may correspond to the coding (or bit rate) of the mono audio encoder 307 for the immediate previous audio frame.

In some embodiments the previous audio coding mode may correspond to a simple binary indicator indicating whether the previous audio frame was encoded by the mono audio encoder 307 as an audio frame or as a speech frame.

In a first group of embodiments the previous audio coding mode may correspond to the coding mode of the mono audio encoder 307, which may be a multi-rate mono audio encoder.

In other embodiments the mono audio encoder 307 may provide the metric data upon which the audio coding mode decision for the mono audio encoder 307 is made.

In the group of embodiments in which the mono audio encoder 307 may be a multi-rate mono audio encoder the metric data provided may be the measurable data upon which the audio coding mode of the multi-rate mono encoder audio encoder is made.

The mono audio coding mode decision information or the metric data upon which the mono audio coding mode decision was made for the previous frame may be passed along the connection 304 to the multichannel audio coding mode determiner 301.

The processing step of retrieving the most recent mono audio coding mode from the mono audio encoder 307 is shown as processing step 409 in FIG. 4.

It is to be understood in embodiments that the retrieval step 409 may directly retrieve the mono audio encoder coding mode used to encode the previous mono audio frame.

It is to be understood in other embodiments the above retrieval step 409 may retrieve the metric data which was used to derive the mode of operation of the mono audio coder 307 for the previous mono audio frame. In these embodiments the multichannel audio coding mode determiner 301 may translate the metric data passed along the connection 304 into a parameter which may be used in the subsequent step of determining the multichannel audio coding mode. For example, such metric data provided by the mono audio encoder 307 may include a pitch evolution vector or voice activity detector (VAD) information. Other examples of such metric data provided by the mono audio encoder 307 may comprise data indicating whether the mono audio encoder operated in either a speech signal mode of encoding or an audio signal mode of encoding for the previous mono audio frame.

The processing step of mapping the metric data from the mono audio encoder 307 to parameters to aide multichannel encoding mode selection process is depicted as processing step 407 in FIG. 4.

In the first group of embodiments most recent coding mode of the mono audio codec may form the third of the three criteria upon which the decision for the multichannel audio coding mode for the current frame is made.

The multichannel audio encoding mode decision step 403 may then combine the three sources of input, in other words the previous multichannel audio coding mode from processing step 405, the similarity measure from processing step 401 and the coding mode information from the mono audio codec 307 as collated by processing step 407 to produce a multichannel audio coding mode decision.

In other words embodiments may have the means for determining a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity. In some embodiments the first audio frame may be a previous audio frame of the multiple channel input audio signal, and the second audio frame may be a current audio frame of the multiple channel input audio signal.

The multichannel audio coding mode decision step 403 may be configured in some embodiments to produce a decision between a number of multichannel audio encoding modes dependent on the three inputs 405, 401, and 407.

In some embodiments the multichannel audio coding mode decision step 403 may be configured to produce a transition mode decision or a generic mode decision.

In further embodiments the transition mode decision may be further divided into sub modes comprising spatial stable mode and spatial transition mode.

The multichannel audio coding mode may be passed to the multichannel spatial audio encoder 303 along the connection 306. The multichannel audio coding mode may then be used by the multichannel spatial audio encoder 303 to select a particular mode of encoding.

The step of passing the determined multichannel audio coding mode to the multichannel spatial audio encoder 303 for the processing of the current frame of the multiple channel audio signal is depicted as processing step 411 in FIG. 4.

The multichannel spatial audio encoder 303 may be arranged dependent on the multichannel audio coding mode to extract audio spatial cues from the input multichannel audio signal 302.

In some embodiments the multichannel spatial audio encoder 303 can be configured to perform any suitable time to frequency domain transformation on the input multichannel audio signal 302 to generate separate frequency band domain representations of each input channel audio signal. Depending on the multichannel audio coding mode these bands can be arranged in any suitable manner. For example these bands can be linearly spaced, or be perceptual or psychoacoustically allocated in order the aide the analysis of the multichannel audio signal.

Depending on the multichannel audio coding mode the multichannel audio encoder 303 may be arranged to determine inter-channel cues for each frequency band which may be realised as a set of relative level and time differences between the multiple audio channels together with a inter-channel correlative measures.

In embodiments the multichannel spatial audio encoder 303 may quintile the inter channel cues in a form suitable for transmission.

In some embodiments the multichannel spatial audio encoder 303 may be configured to encode the parameters in such a manner that the quantizer for the inter channel cues may depend on the multichannel audio coding mode.

In embodiments the audio encoder 104 can comprise a down mixer 305 which may be configured to receive the audio signal frequency domain representations for at least a pair of the audio channels from the multichannel audio encoder 303 and generate a mono audio channel from the multichannel audio signals.

In some embodiments for example in a two channel (left and right channel) audio signal system the left and right channels are combined into a mono audio channel by using relative shift information from the multi-channel audio encoder 303.

The down mixer 305 can output the generated mono audio channel to the mono audio encoder 307.

The mono audio encoder 307 can be configured to receive the mono audio channel generated by the down mixer 305 and encode the mono channel in any suitable format.

In embodiments the mono audio encoder 307 can operate in a number of different encoding modes. The mono audio encoder 307 may operate as a multi-rate mono audio encoder with the capability of operating in any one of a number of codings (or bit rates). Each combination of coding (or bit rate) may be particular coding mode of the mono audio encoder 307.

In other embodiments the mono audio encoder 307 may operate as an embedded scalable encoder comprising multiple coding layers each having a specific amount of allocated bits. Typically such an encoder may have a core layer providing the lowest bit rate coding with additional coding layers being added to the core layer in order to improve the quality of the encoded audio signal. Each combination of allowable coding layers may be termed a particular coding mode of the mono scalable encoder 307.

In some embodiments the mono audio encoder 307 can be an EVS mono channel encoder, which may contain a bit stream interoperable version of the AMR-WB codec. However, any suitable encoding method can be implemented.

The output from the mono encoder 307 can in some embodiments be passed to a multiplexer 308.

The multiplexer 308 can be configured to multiplex the encoded mono channel and the encoded multichannel audio values and to generate a single output data stream.

In order to fully show the operations of the codec with respect to some embodiments, FIG. 5 shows the operation of the decoder 108.

In some embodiments the decoder comprises a de-multiplexer 501. The de-multiplexer 501 is configured to receive the multiplexed signal 112 and to de-multiplex the signal into encoded mono signal and encoded multichannel spatial audio parameters.

The de-multiplexer can in some embodiments be configured to output the encoded mono parameters to a mono audio decoder 503 and the encoded multichannel spatial audio parameters to the multichannel spatial audio decoder 505.

The mono audio decoder 503 can be configured to perform the inverse or reciprocal arrangement to the mono audio encoder 307 shown in FIG. 3.

The mono audio decoder 503 can be configured to output the decoded mono audio channel to the multichannel spatial audio decoder 505.

The multichannel spatial audio decoder 505 is configured in some embodiments to receive the mono decoded audio signal and the multichannel spatial audio parameters and generate or reconstruct the separate multiple channels of the audio signal 114 dependent on the multichannel spatial audio parameters.

Although the above examples describe embodiments of the application operating within a codec within an apparatus 10, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-37. (canceled)

38. An apparatus comprising at least one processor and at least one memory including computer program code for one or more programs, the at least one memory and the computer program code configured to, with the at least one processor, cause the apparatus at least to:
determine an indication of similarity between a first audio frame of a multiple channel input audio signal and a second audio frame of the multiple channel input audio signal; and
determine a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.

39. The apparatus as claimed in claim 38, wherein the multiple channel audio spatial encoder is arranged to operate in one of a plurality of coding modes, and wherein the mono audio encoder is arranged to operate in one of a further plurality of further coding modes.

40. The apparatus as claimed in claim 38, wherein the indication of similarity is a measure of the evolution of a spectral shape between the first audio frame of the multiple channel input audio signal and the second audio frame of the multiple channel input audio signal for each channel of the multiple channel input audio signal.

41. The apparatus as claimed in claim 40, wherein the measure of the evolution of the spectral shape signifies a change in the relative dominance of the audio signal level from one channel to another channel of the multichannel audio signal over the duration from the first audio frame to the second audio frame.

42. The apparatus as claimed in claim 38, wherein the indication of similarity is dependent on the evolution of spatial audio cues between the first audio frame of the multiple channel input audio signal and the second audio frame of the multiple channel input audio signal for each channel of the multiple channel input audio signal.

43. The apparatus as claimed in claim 42, wherein the measure of the evolution of the spatial audio cues signifies a transition of the spatial audio cues within the audio space over the duration from the first audio frame to the second audio frame.

44. The apparatus as claimed in claim 38, wherein the data indicating the coding mode of the mono audio encoder for the first audio frame of the multiple channel input audio signal comprises metric data used to derive the coding mode of the mono audio encoder.

45. The apparatus as claimed in claim 44, wherein the metric data comprises at least one of: voice activity detector data; and a pitch evolution vector.

46. The apparatus as claimed in claim 38, wherein the data indicating the coding mode of the mono audio encoder for the first audio frame indicates whether the mono audio encoder operated in either a speech signal mode of encoding or an audio signal mode of encoding.

47. The apparatus as claimed in claim 38, wherein the mono audio encoder is a variable bit rate mono audio encoder, wherein each coding mode of the variable bit rate mono audio encoder corresponds to an operating bit rate of the mono audio encoder, and wherein the data indicating the coding mode of the mono audio encoder for the first audio frame indicates the operating bit rate of the mono encoder.

48. The apparatus as claimed in claim 38, wherein the first audio frame of the multiple channel input audio signal is a previous audio frame of the multiple channel input audio signal, and wherein the second audio frame of the multiple channel input audio signal is a current audio frame of the multiple channel input audio signal.

49. The apparatus as claimed in claim 38, wherein the at least one memory and the computer program code is further configured to, with the at least one processor, cause the apparatus at least to:
convert the second audio frame of the multiple channel input audio signal to a mono audio signal; and
encode the mono audio signal with the mono audio encoder.

50. A method comprising:
determining an indication of similarity between a first audio frame of a multiple channel input audio signal and a second audio frame of the multiple channel input audio signal; and
determining a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.

51. The method as claimed in claim 50, wherein the multiple channel audio spatial encoder is arranged to operate in one of a plurality of coding modes, and wherein the mono audio encoder is arranged to operate in one of a further plurality of further coding modes.

52. The method as claimed in claim 50, wherein the indication of similarity is a measure of the evolution of a spectral shape between the first audio frame of the multiple channel input audio signal and the second audio frame of the multiple channel input audio signal for each channel of the multiple channel input audio signal.

53. The method as claimed in claim 50, wherein the indication of similarity is dependent on the evolution of spatial audio cues between the first audio frame of the multiple channel input audio signal and the second audio frame of the multiple channel input audio signal for each channel of the multiple channel input audio signal.

54. The method as claimed in claim 50, wherein the data indicating the coding mode of the mono audio encoder for the first audio frame of the multiple channel input audio signal comprises metric data used to derive the coding mode of the mono audio encoder.

55. The method as claimed in claim 50, wherein the data indicating the coding mode of the mono audio encoder for the first audio frame indicates whether the mono audio encoder operated in either a speech signal mode of encoding or an audio signal mode of encoding.

56. The method as claimed in claim 50, wherein the mono audio encoder is a variable bit rate mono audio encoder, wherein each coding mode of the variable bit rate mono audio encoder corresponds to an operating bit rate of the mono audio encoder, and wherein the data indicating the coding mode of the mono audio encoder for the first audio frame indicates the operating bit rate of the mono encoder.

57. The method as claimed in claim 50, wherein the first audio frame of the multiple channel input audio signal is a previous audio frame of the multiple channel input audio signal, and wherein the second audio frame of the multiple channel input audio signal is a current audio frame of the multiple channel input audio signal.

58. The method as claimed in claim 50, further comprising:
converting the second audio frame of the multiple channel input audio signal to a mono audio signal; and
encoding the mono audio signal with the mono audio encoder.

59. A computer program product embodied on a non-transitory computer readable medium, comprising computer program code configured to, when executed on at least one processor, cause an apparatus to:
determine an indication of similarity between a first audio frame of a multiple channel input audio signal and a second audio frame of the multiple channel input audio signal; and
determine a coding mode for a multiple channel audio spatial encoder dependent on each of: data indicating a coding mode of a mono audio encoder for the first audio frame of the multiple channel input audio signal; a coding mode of the multichannel spatial audio encoder for the first audio frame of the multiple channel input audio signal; and the indication of similarity.
